(19) United States
(12) Patent Application Publication
(10) Pub. No.: US 2007/0256442 A1
(43) Pub. Date: Nov. 8, 2007

(54) Motorized ice dispenser door

(75) Inventors: Daniel W. Lyvers, Greenwood, MS (US); Alan Clark Webb, Grenada, MS (US); Robert David Rendel, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation, Greenwood, MS (US)

(21) Appl. No.: 11/417,066

(22) Filed: May 3, 2006

(51) Int. Cl. G07F 9/10; F25C 5/18

(52) U.S. Cl. 62/344; 221/150 R

(57) ABSTRACT

An ice dispenser includes an ice chute door. The dispenser further includes a shaft coupled to the door, a motor coupled to the shaft, and a biasing device, such as a spring, coupled to the door. The motor rotates the shaft to open the door. To close the door, the motor is de-energized after a predetermined time period, and the biasing device then closes the door with a strong sealing force.

### FIELD OF THE INVENTION

One embodiment of the present invention is directed to a refrigerator ice dispenser. More particularly, one embodiment of the present invention is directed to an ice chute door of a refrigerator ice dispenser.

### BACKGROUND INFORMATION

Consumer ice dispensers that dispense through a freezer compartment door of a refrigerator typically have an ice chute door that prevents or restricts warm moist air from entering the refrigerated compartment. The door is usually held in its sealing position by a bias spring. When either crushed or cubed ice is requested by the user, the door is fully opened by several different mechanisms initiated by pressure from a receptacle, usually a drinking glass. Known door opening mechanisms include cams and electromechanical solenoids. When the glass is sufficiently full the user removes the pressure from the mechanisms and the door is closed by the spring at a rate determined by a mechanical dashpot.

A limiting factor on many current ice chute doors that rely on a mechanical mechanism to open the door is that the user has to overcome the force of the return bias spring that typically holds the door closed. The return spring has to be weak enough for the user to be able to easily open the door. However, a weak return spring means that its sealing force of the door is marginal, which introduces an undesirable moisture path and increases the costs to operate the refrigerator.

Based on the foregoing, there is a need for an improved ice chute door that provides a better sealing force while being easy for a user to open.

### SUMMARY OF THE INVENTION

One embodiment of the present invention is an ice dispenser that includes an ice chute door. The dispenser further includes a shaft coupled to the door, a motor coupled to the shaft, and a biasing device, such as a spring, coupled to the door. The motor rotates the shaft to open the door. To close the door, the motor is de-energized after a predetermined time period, and the biasing device then closes the door with a strong sealing force.

### BRIEF DESCRIPTION OF THE DRAWINGS

FIG. 1 is a front view of a refrigerator that implements one embodiment of the present invention.

FIG. 2 is a front perspective view of a dispenser and illustrates the cavity of the dispenser in accordance to one embodiment of the present invention.

FIG. 3 is a perspective view of an ice door module in accordance to one embodiment of the present invention.

FIG. 4 is a front perspective view of a dispenser in accordance to one embodiment of the present invention and illustrates the ice chute door in an open position.

FIG. 5 is a perspective view of an ice door module in accordance to another embodiment of the present invention.

FIG. 6 is a perspective view of an ice door module in accordance to another embodiment of the present invention.

### DETAILED DESCRIPTION

One embodiment of the present invention is an ice dispenser door that is opened by a motor and closed, after a predetermined time delay, by a spring or other closure means. The use of a motor allows the spring or other means to apply greater force on the closed door.

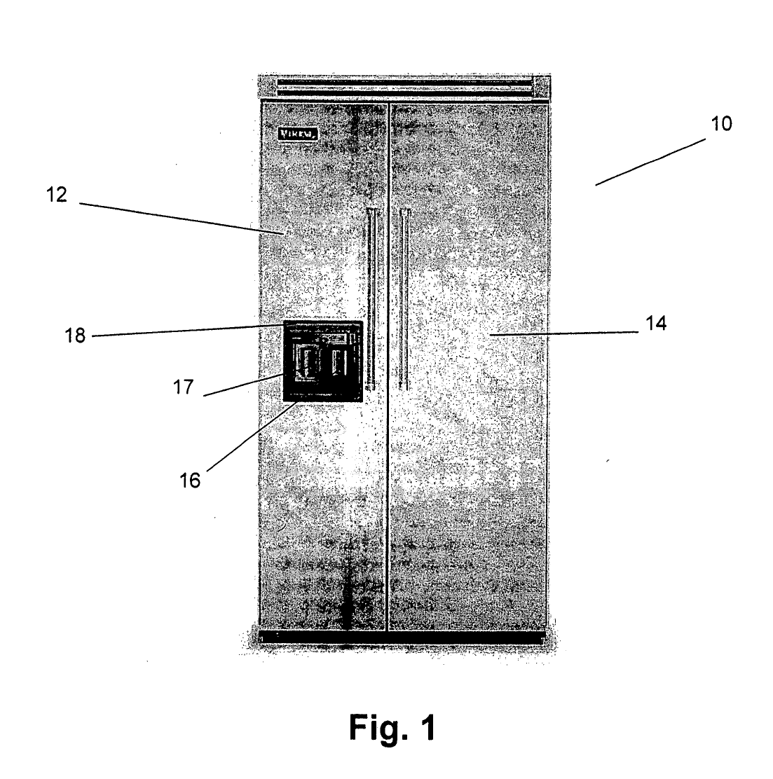

FIG. 1 is a front view of a refrigerator 10 that implements one embodiment of the present invention. Refrigerator 10 includes a freezer section door 12 and a refrigerator section door 14, shown in closed positions. Freezer door 12 includes a through the door ice and water dispenser 18. Dispenser 18 includes levers 17 and 16 that can be pressed via an object such as a drinking glass. Pressing on lever 17 initiates delivery of ice (cubed or crushed) to the drinking glass. Pressing on lever 16 initiates delivery of water to the drinking glass. Dispenser 18 further includes an ice chute which delivers ice from inside refrigerator 10 to the drinking glass external to refrigerator 10. An ice chute door (not shown) closes the opening of the ice chute when dispenser 18 is not being used.

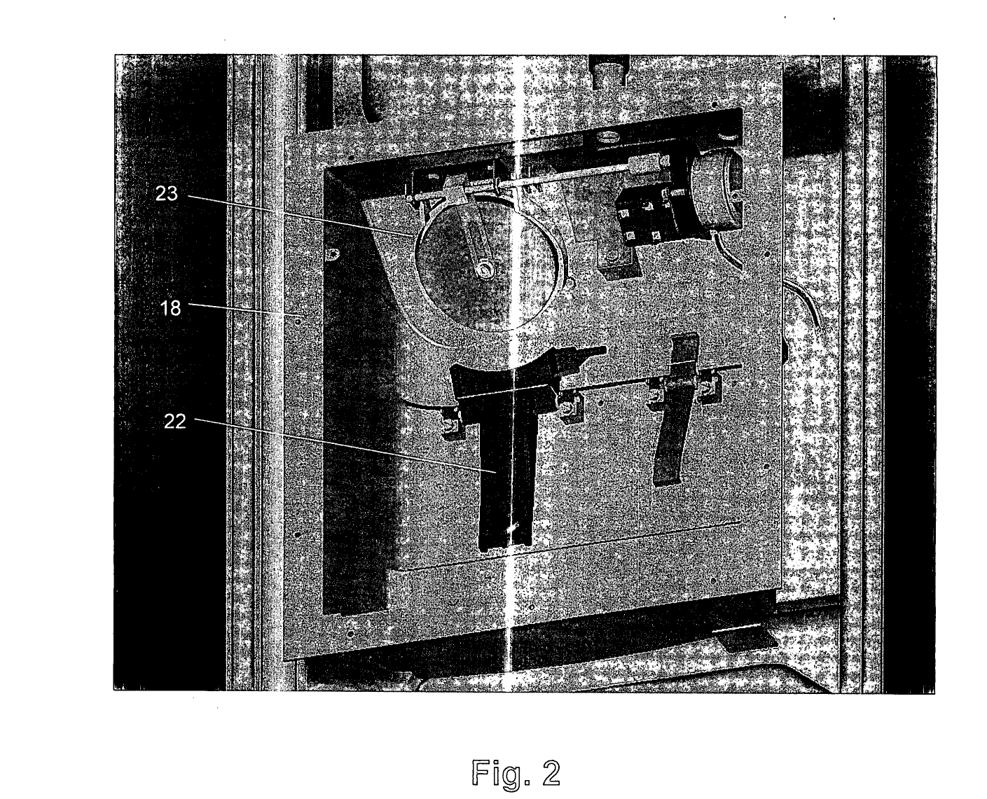

FIG. 2 is a front perspective view of dispenser 18 and illustrates the cavity of dispenser 18 in accordance to one embodiment of the present invention. The ice portion of dispenser 18 includes an actuation arm 22 with spring return and an ice door module 23. Actuation arm 22 is coupled to lever 17 of FIG. 1 and indicates to ice door module 23 when lever 17 is being pressed through a switch (not shown) which coupled to arm 22.

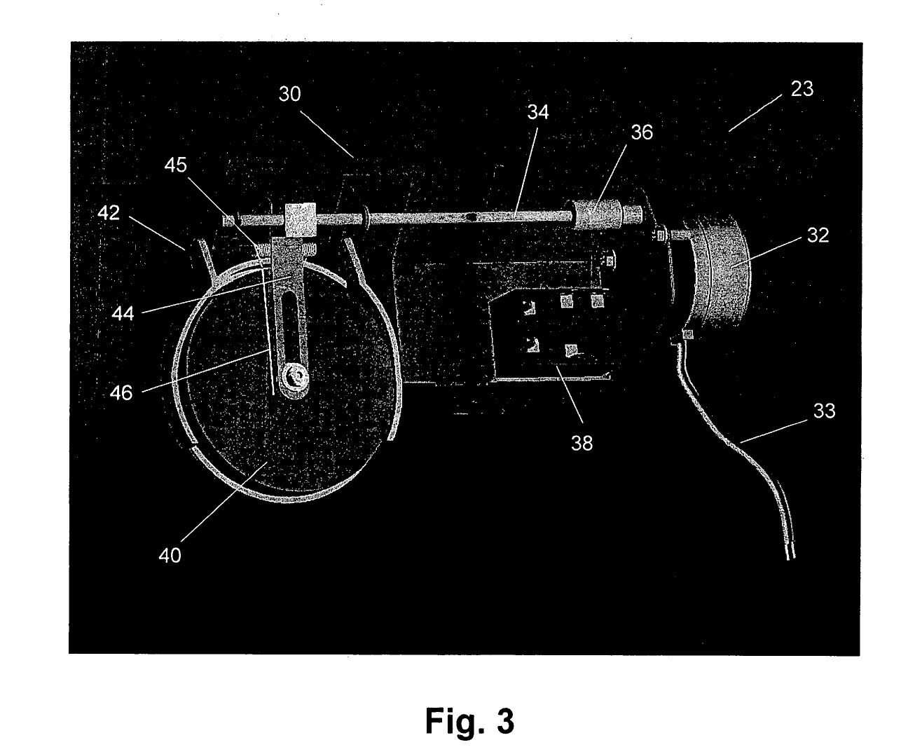

FIG. 3 is a perspective view of ice door module 23 in accordance to one embodiment of the present invention. Door module 23 includes an insulated ice chute door 40 and a mounting bracket 30. Door module 23 further includes a motor 32 that is coupled to a power source via power cord 33. In one embodiment, motor 32 is an alternating current (“AC”) asynchronous motor. Motor 32 is coupled to a rotating horizontal shaft 34 via a shaft connection 36. A time delay relay 38 is coupled to motor 32 via a wire harness (not shown).

Ice chute door 40 is mechanically attached to shaft 34 via bracket 44. A pre-loaded torsion return spring 45 along a spring shaft 42 presses on door 40 at spring arm 46 to bias door 40 in the closed position. As shown in FIG. 3, door 40 is shown in the closed position.

In operation, voltage is supplied to motor 32 through the switch which is activated by actuation arm 22 when a user presses on lever 17. Once voltage is supplied, motor 32 turns slowly to rotate shaft 34, which causes ice chute door 40 to open. Once actuation arm 22 is released, motor 32 remains energized for a pre-determined period of time. In one embodiment, the period of time is eight seconds. When the time delay has timed out, motor 32 de-energizes and return spring 45 slowly overcomes the minimal internal resistance of de-energized motor 32 and closes ice chute door 40. The pre-determined delay allows all of the ice to exit through the chute and prevents ice from getting trapped behind door 40.

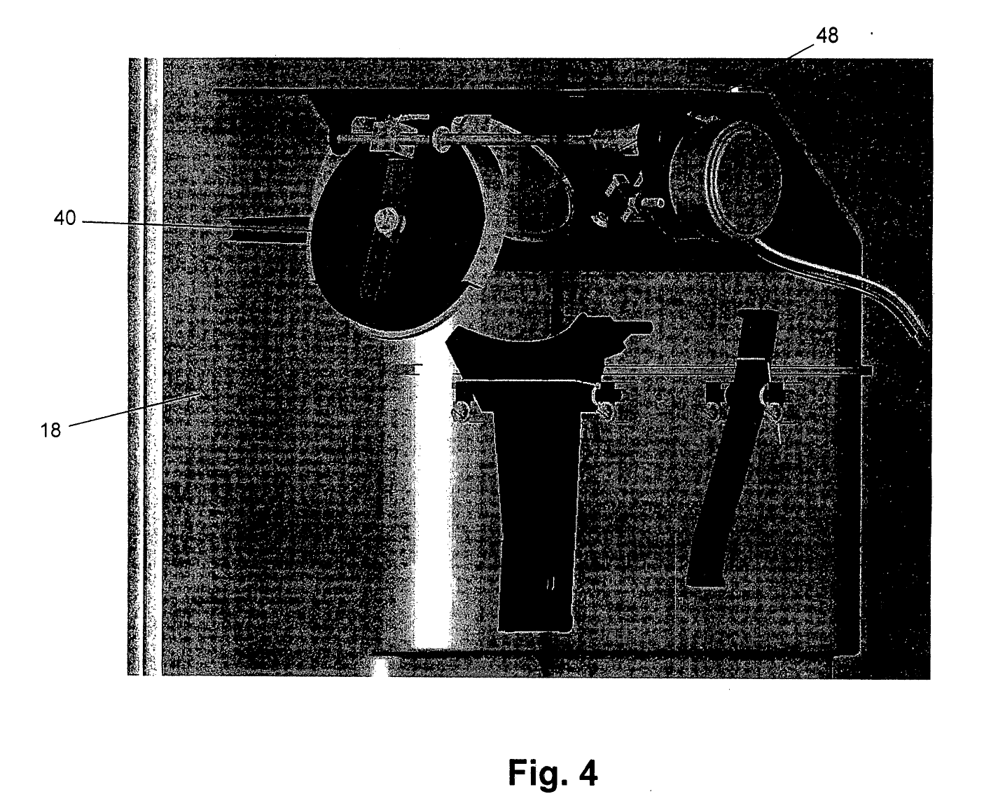

FIG. 4 is a front perspective view of dispenser 18 in accordance to one embodiment of the present invention and illustrates ice chute door 40 in an open position. In this position, the ice chute 48 is accessible to exiting ice cubes.

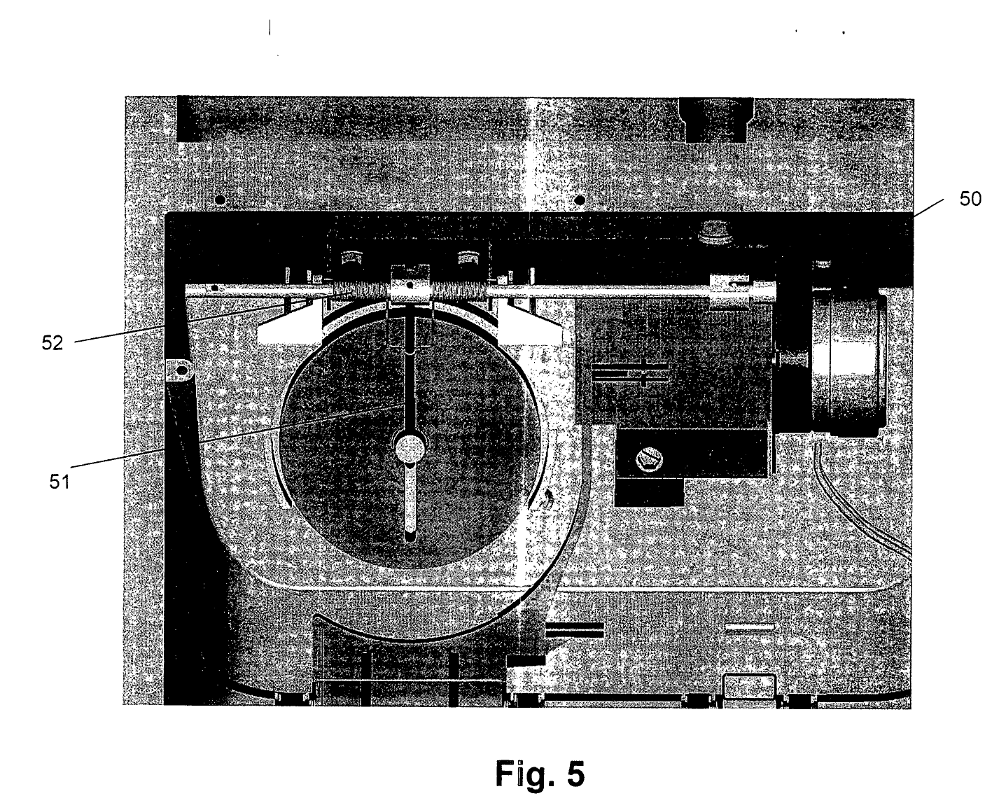

FIG. 5 is a perspective view of an ice door module 50 in accordance to another embodiment of the present invention. Door module 50 is similar to door module 23 except for bias spring 52 and bracket 51.

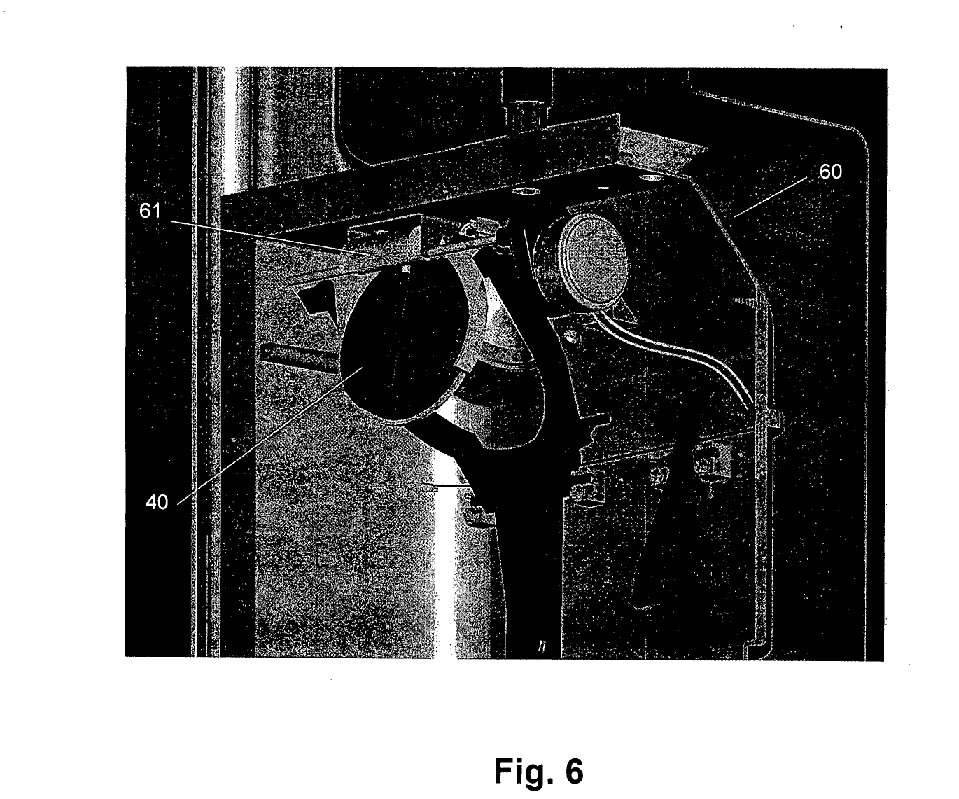

FIG. 6 is a perspective view of an ice door module 60 in accordance to another embodiment of the present invention. Door module 60 is similar to door module 50, except it includes a counter balance weight 61 instead of a spring to return door 40 back to the closed position.

As disclosed, embodiments of the present invention use a motor to open the ice chute door, and after a pre-determined time delay, use a spring or other means to slowly close the door. The spring or other means can apply a heavier force than in prior art ice dispensers, thus creating a greater sealing force.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. An ice dispenser comprising:
an ice chute door;
a shaft coupled to said door;
a motor coupled to said shaft; and
a biasing device coupled to said door.

2. The ice dispenser of claim 1, further comprising:
a relay coupled to said motor, said relay adapted to remove power to said motor after a pre-determined time delay.

3. The ice dispenser of claim 1, wherein said biasing device is a spring.

4. The ice dispenser of claim 1, wherein said biasing device is a counter balance weight.

5. The ice dispenser of claim 1, wherein said motor is an alternating current asynchronous motor.

6. The ice dispenser of claim 1, further comprising a lever coupled to a switch, wherein said motor, when activated by a force on the lever, rotates said shaft to open said door.

7. The ice dispenser of claim 6, wherein said relay removes power to said motor after a predetermined time delay when the force is removed.

8. A method of operating an ice dispenser having an ice chute door comprising:
receiving a first indication to dispense ice;
energizing a motor that is coupled to the ice door, said motor rotating a shaft to open the ice door;
receiving a second indication to stop dispensing ice; and
de-energizing the motor after a predetermined time delay from receiving the second indication.

9. The method of claim 8, further comprising:
biasing the ice door in a closed position using a spring.

10. The method of claim 8, further comprising:
biasing the ice door in a closed position using a counter balance weight.

11. The method of claim 8, wherein the first indication is a force on a lever, and the second indication is a removal of the force.

12. A refrigerator comprising:
a freezer section door; and
a refrigerator section door;
said freezer section door having an ice dispenser comprising:
an ice chute;
an ice chute door coupled to said ice chute;
a shaft coupled to said door;
a motor coupled to said shaft; and
a biasing device coupled to said door.

13. The refrigerator of claim 12, further comprising:
a relay coupled to said motor, said relay adapted to remove power to said motor after a pre-determined time delay.

14. The refrigerator of claim 12, wherein said biasing device is a spring.

15. The refrigerator of claim 12, wherein said biasing device is a counter balance weight.

16. The refrigerator of claim 12, wherein said motor is an alternating current asynchronous motor.

17. The refrigerator of claim 12, further comprising a lever coupled to a switch, wherein said motor, when activated by a force on the lever, rotates said shaft to open said door.

18. The refrigerator of claim 17, wherein said relay removes power to said motor after a predetermined time delay when the force is removed.
